(19) United States
(12) Patent Application Publication
(10) Pub. No.: US 2006/0110160 A1
(43) Pub. Date: May 25, 2006

(54) Method and device for the transmission of information by means of an optical data transmission system

(76) Inventor: Eric Hoedt, Rodermark (DE)

Correspondence Address: SIMPSON & SIMPSON, PLLC, 5555 MAIN STREET, WILLIAMSVILLE, NY, 14221-5406, US

(21) Appl. No.: 10/523,737

(22) PCT Filed: Aug. 5, 2003
(86) PCT No.: PCT/EP03/50361

§ 371 Date: Nov. 2, 2005

(30) Foreign Application Priority Data
Aug. 6, 2002 (DE) 102 36 046.4

(51) Int. Cl. H04B 10/24

(52) U.S. Cl. 398/41

(57) ABSTRACT

The invention relates to a method for the transmission of information by means of an optical data transmission line, the ends of which are embodied as an optoelectronic interface, whereby a light source which can be modulated, such as for example a laser, is provided on the transmission side and a light sensitive receiver element is provided on the receiving side, such as for example a photodiode. The signal varying with the received light intensity at the output from the receiving element is amplified and processed. The light received by the receiver element is recorded as such, independent of the current strength of he modulated signal and displayed at a signal monitoring output to show the presence or otherwise of a data signal. The invention further relates to a corresponding device. According to the invention, the emitted light on the transmission side may be reduced so far below the minimum modulation level such that on the receiver side the threshold value for the display of a received signal by the signal monitoring device is dropped below and thus the output of the signal monitoring device has an error signal and then the emitted light is restored above the said threshold level such that the signal monitoring device shows the presence of an optical signal. Said reduction and resumption of the light energy occurs in a cycling coded form and the output signal from the signal monitoring device is used as receiver side data output and correspondingly analysed, whereby the light emitted on the transmission side is reduced so far below the minimum threshold value of the signal amplitude used for data transmission that the signal monitoring output on the receiver side end, registers and displays an error input signal for the light receiving element. The emitted light is then again restored to above the threshold, whereby the reduction and restoration of the light energy occur in a relatively slow time cycle in coded form and the corresponding coded signal from the signal monitoring output is evaluated by a corresponding analytical logic.

The present invention relates to a method and a device for the transmission of information via an optical data transmission line the ends of which, laid remote from each other, are each formed by an optoelectronic interface, with a light source which can be modulated, such as e.g. a laser, being provided transmitter side and a light-sensitive receive element, such as e.g. a photodiode, being provided receiver side. Without limitation being intended, for the sake of simplicity reference will be made hereafter only to a laser as transmit light source, it being of course possible to also use, as transmitter, other kinds of light sources which can be switched and/or modulated. Transmitter side, data in the form of a modulated transmit power of the laser are fed into an optical transmission fibre, and received receiver side by the light-sensitive receive element, such as e.g. a photodiode, an output current of the photodiode being modulated corresponding to the modulation of the received laser signal and the data accordingly being able to be evaluated in an electronic system. In addition, with a corresponding method and the associated device, a monitoring device is also provided on the receiving side which, independently of the modulation amplitude, displays the presence of an adjacent optical signal. The binary data are thus coded by “modulation” in that, transmitter side, light is transmitted on two different levels and these two different levels are also recorded receiver side and interpreted as binary data. During the transmission of data, there is thus a variation of the transmit power only between two levels distinguishable from one another but which, on the receiver side, both differ clearly from a zero level such as would occur for example when the transmit laser is switched off.

With corresponding systems, however, there are repeated disturbances not only of the data transmission lines themselves, but also of the transmit and receive systems. The result of this may be that, although optical signals can in principle still be transmitted, at least in one direction, disturbances can still occur in the signal shape or the signal cycle or also in the type of coding, with the result that, receiver side, the data can no longer be meaningfully or correctly interpreted and/or converted. Transmitter side, data formats could for example also be used which cannot be correctly recognized on the receiver side. In the event of such disturbances, communication between the transmit and receive systems is practically eliminated, as such communication requires the correct interpretation of the transmitted and received data. Such a situation can occur for example if one of the components on the transmit or receive side is malfunctioning or has failed.

In this situation it is expedient and desirable to at least be able to exchange data about the system state on both side or at least to be able to communicate on one side, in order to be able if necessary to switch to another operational mode, or be able to exchange other information which makes it possible for either transmitter or receiver to adapt itself to the respective other side, in order to properly restore the connection and make data transmission possible. Even if a corresponding switch-over or adjustment of transmit and receive sides is not possible, communication about this state is also important for both sides, because a change to another connection is then possible if necessary and because a corresponding alarm signal can then also be emitted if necessary in order to arrange a repair and/or an exchange of systems and system components.

It is therefore desirable for an optical data transmission system to have a method independent of the actual optical data transmission channel and a corresponding device for data transmission which, even if there are disturbances in the optical data communication, make it possible to transmit and exchange information from one side to the other.

With regard to the method mentioned at the start, this object is achieved in that, transmitter side, the quantity of light emitted is reduced so far below the lower modulation level that, receiver side, the threshold value for the display of a received signal by the signal monitoring device is not reached and thus the output of the signal monitoring device displays a missing signal and then the emitted light energy is raised above this threshold value again, so that the signal monitoring device displays the presence of an optical signal, this lowering and raising being clock-pulse-controlled in encoded form and the output signal from the signal monitoring device being able to be used as receiver-side data output and correspondingly evaluated.

In contrast to the rapid modulation of a laser between its two transmission levels, the lowering of the transmit power below a threshold value which, receiver side, is interpreted as a missing signal is a relatively slow process and also the signal monitoring device does not generally operate at the high data-acquisition speed of the electronic components for the processing of the normal input signals. In practice, in a prototype, data transmission rates of only 1 bit/8 ms are used. The quantity of data transmitted in this way is therefore extremely small and is for example only approximately 1/10,000 to 1/100,000 of the normal high-speed transmission, but is perfectly adequate to guarantee communication about possibly faulty system states. The additional and comparatively slow channel provided in this way for data transmission is therefore also not used for normal data transmission, but serves exclusively for communication about system states and if necessary to deal with faults and adapt the transmitter to the receiver and vice versa. It is understood that during operation of this additional channel, at least during the lowering of the light energy, the “normal” data transmission is interrupted, but in principle this is not a problem because, as already mentioned, this additional channel is used only if disturbances or problems occur in normal data transmission. Normal data transmission is in any case not possible during such operating states.

At the same time, however, this slow data transmit signal is extremely robust and insensitive to disturbance, as it is not dependent on the highly complex and sensitive components of high-speed processing which are responsible for the modulation and the reception and the evaluation of the “normal” data transmission signals.

Data transmission is preferably asynchronous, with a start bit and a stop bit, which respectively indicate the beginning and end of a data word and from which a defined time cycle results receiver side. The specifications preferably correspond to a so-called V 24 or RS 232 interface. Other coding methods can of course also be used.

In the preferred version of the invention, the corresponding laser electronics are triggered via a “Laser Enable” signal and the data are transmitted via the slow channel by “Laser Enable” and “Laser Disable”. When the “Laser Enable” signal is switched off, or in the case of “Laser Disable”, the laser is practically completely switched off, so that, on the receiver side, the signal monitoring device accordingly records and displays a missing signal. Alternatively, the supply voltage to the laser electronics could also be switched on and off.

The evaluation logic on the receiver side for the output signal of the signal monitoring device can in the simplest case be implemented by software and the evaluation can moreover be carried out by the same components and processors which otherwise also evaluate and/or convert data received via the “normal” transmission route. Alternatively however a separate microprocessor can also be provided, which is provided exclusively for the evaluation of the output signal of the monitoring device and which is independent of the other data acquisition of the normally transmitted data. A relatively simple and low-cost, slow microprocessor can be used for this purpose. The evaluation could also take place direct by means of hardware logic.

It is understood that the corresponding devices and also the corresponding software for the bi-directional operation are provided on both sides of a transmission line. Particularly preferably the present invention is used in conjunction with a method and a device such as are disclosed in the same applicant's as yet unpublished German patent application No. 102 10 768.8, which relates to an optical switching matrix with several optoelectronic interfaces and the operation thereof.

Further advantages, features and possible uses of the present invention are to be found in the following description of a preferred version and the associated figures. These show:

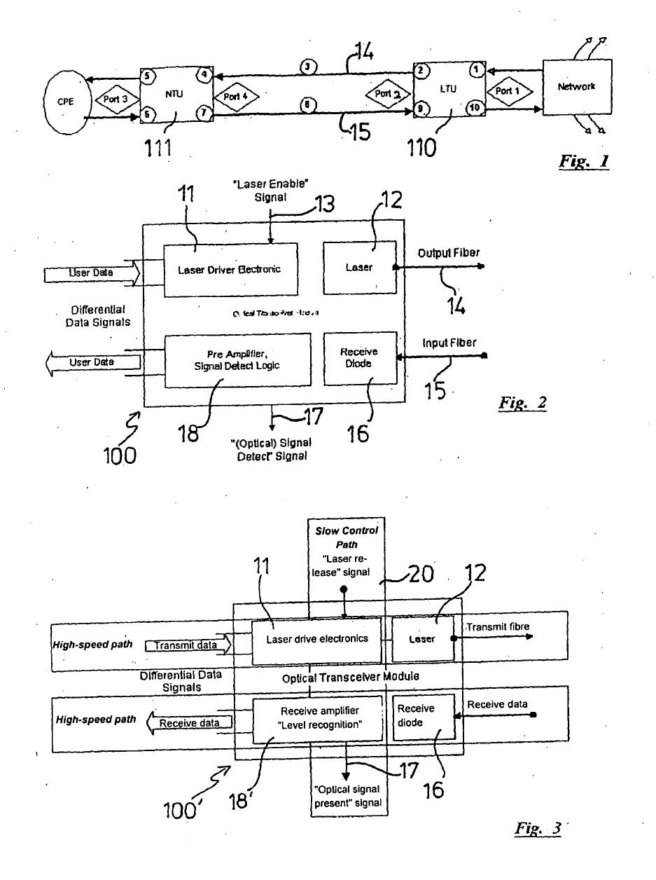

FIG. 1: diagrammatically an optical transmission route with an optoelectronic interface at each of the two ends,

FIG. 2: a part of the optoelectronic interfaces from FIG. 1 and

FIG. 3: a variant of an optoelectronic interface according to FIG. 3.

An optical data transmission route, consisting of optical fibres 14 and 15, between two optoelectronic interfaces 110 and 111 respectively (more precisely, these are two optical-electrical-optical interfaces) can be seen in FIG. 1. In relation to the optoelectronic interface 110, also called “LTU” (for “Line Terminal Unit”), the optical fibre 14 is the output fibre and the optical fibre 15 the input fibre. On the opposite side there is an optoelectronic interface 111, called “NTU” (for “Network Terminal Unit”) which is constructed as a mirror image of the optoelectronic interface 110. A customer-side CPE (Customer Premises Equipment) network for example connects to the latter, while the central station of a network operator can be on the side of the LTU 110 facing away from the optical transmission route. The two interfaces 110 and 111 operate electrically internally, but have optical input and output connections or leads to the outside (on both sides).

The circled numbers 1 to 10 mark all the positions in the optical transmission route including the optoelectronic interface at which faults typically occur which can be recorded and communicated by the system according to the invention, as will be described hereafter with reference to FIGS. 2 and 3.

In FIG. 2 there can again be seen, and in more detail, an optoelectronic interface 110 which corresponds to half each of one of the interfaces 110 and 111 respectively. In detail, this optoelectronic interface 100 has a laser 12 transmitter side and a receive diode 16 receiver side, corresponding electronics being assigned to each of these two main components. The laser 12 is actuated by drive electronics 11 and these drive electronics 11 are in turn actuated via a “Laser Enable” signal at a signal input 13, the associated electronics producing this signal also being able to be integrated into the drive electronics 11. For the present invention it is essential only that access is possible to the “Enable” input 13, so that the “Laser Enable” can be switched on and off alternatively and in a controlled manner. For normal data transmit operation the “Laser Enable” signal is switched on permanently and the drive electronics 11 modulate the laser 12 corresponding to an incoming (electric) data stream, the laser 12 essentially being operated or “modulated” between two different power levels, which each correspond to a digital “0” or “1” respectively.

On the input side the receive diode 16 is connected to a corresponding preamplifier and signal detection logic. Independently of this signal detection logic or alternatively also integrated into the latter, a signal monitoring device not represented in FIG. 2 is provided, which displays a “Signal Detect” signal at an output 17. This monitoring device thus records whether an optical input signal of sufficient strength is present at all at the receive diode, so that it can be clearly assigned to a transmit level standing for a digital “0” or “1”.

FIG. 3 shows once again an optoelectronic interface 100′ according to FIG. 2, but in this case only those elements which are essential for the present invention are represented. In this case a microprocessor 20 is additionally provided, although this microprocessor is by no means absolutely necessary and the method according to the invention can also be carried out with just the components described in connection with FIG. 2. In the case of the special version represented in FIG. 3, the “Laser Enable” signal, which is here called a “Laser Release” signal, is actuated via the microprocessor 20 (although, as already mentioned, this could also be done by one of the electronics systems provided in any case at the interface or its periphery). This “Laser Release” signal at the corresponding input 13 of the drive electronics 11 is switched on and off by the microprocessor 20 in encoded manner if a malfunction is recorded at one of the positions 1 to 10 indicated in FIG. 1. Expediently, the encoded signal is transmitted asynchronously with a start bit, which can for example consist of an “off” to “on” switch, the “on” state being held for e.g. 4 or 8 ms. Analogously, a corresponding stop bit can also be provided, start bit and stop bit forming the beginning and end of a data word which, corresponding to a usual convention, consists of for example 8 bytes of information. Of the preamplifier and signal-recording logic from FIG. 2, only the signal monitoring device, which is here represented as “level recognition” 18′ of the receive amplifier, is shown in FIG. 3. Corresponding to the switching on and off of the “laser release signal” at the corresponding input 13 of the laser electronics, the level recognition 18′ reacts at the other end of the transmission route, by displaying either an “optical signal present” or “optical signal not present” signal at the output 17. This change of state at the output 17 of the level recognition follows exactly the same pattern as the “laser release signal” at the “Enable” input 13 of the laser electronics. It is understood that the diode 16 and the level recognition 18′ are in each case those which are arranged at the end of the transmission route opposite the laser 12. In other words, the optoelectronic interfaces 100 and 101 are to that extent constructed as mirror images of each other and each have the same circuits or devices for producing and receiving the encoded signals which are produced by switching the “Laser Enable” on and off and are received and analyzed by recording of the level recognition signal.

If an occurring fault lies e.g. in the optical transmission routes 3 or 8 or directly at the corresponding output and input elements 2 or 4, or 7 or 9 (laser and receive diode), a data transmission corresponding to the method according to the invention is probably only still possible via the remaining transmission route in each case. In other words, both optoelectronic interfaces should preferably each be able to function either as transmitter or also as receiver and, depending on the occurring fault, accordingly that side should be active as transmitter whose transmit route is still intact to the extent that at least the optical signals are still recorded by the receive diode and recognized in the level recognition as signals with an adequate level.

The invention thus makes possible, in simple fashion, an additional data transmission, independent of the actual optical data stream, even if it is extremely slow compared with the normal transmission route. This additional, slow data channel is however extremely robust, requires no complex and expensive high-speed components of any kind for the recording and analysis of the data, and in this way makes possible communication about current operating states, disturbances and their elimination, even if the actual high-speed channels, in spite of their considerably higher data capacity, are no longer able to transmit corresponding data. In particular, the corresponding software and hardware for this data communication concerning operating states and faults does not then also need to be tuned to the high-speed data transmission.

The present invention can moreover be fully implemented in software and requires no additional hardware of any kind, as long as the software-controlled switching of the “Laser Enable” signal on the one hand, and on the other hand the recording of the level recognition signal which can be evaluated by the corresponding software is guaranteed.

What is claimed is:

1. A method for the transmission of information via an optical data transmission line, at least one end of which being provided with an optoelectronic interface having a transmitter side and a receiver side, a light source which can be modulated to carry information through a light signal by data transmission being provided transmitter side, and a light-sensitive receive element, for converting light to an electrical signal that varies with intensity of light received by the receive element being provided receiver side, said method comprising:
amplifying and processing a signal at an output of the receive element;
monitoring and recording signal intensity of light received by the receive element independently of current strength of the electrical signal to obtain a signal monitoring output;
displaying the recorded signal at a signal monitoring device to show the presence or absence of a data signal;
lowering intensity of light at the transmitter side so far below a minimum threshold value of signal amplitude used for the data transmission that the signal monitoring output at the receive-side end records and displays a missing input signal of the light receive element;
again raising emitted light intensity above the threshold value;
and repeatedly the lowering and raising of the light intensity in time cycle in encoded form to provide an encoded signal monitoring output; and
evaluating the encoded signal monitoring output by a corresponding evaluation logic.

2. A method according to claim 1, wherein a laser is provided as transmit element to provide a laser signal and a photodiode is provided as a receive element, and a laser supply voltage signal is switched on and off by drive electronics of the laser using a “Laser Enable” signal.

3. A method according to claim 1, wherein the laser supply voltage is switched on and off in encoded form.

4. A according to claims 1 wherein the evaluation logic is implemented by software.

5. A according to claim 1 wherein the evaluation takes place in a separate microprocessor independent of the evaluation of the normal data signal.

6. A according to claim 1 wherein signal monitoring output provides data in the form of data words and a start bit is transmitted at the beginning of a transmitted data word and a stop bit at the end of the data word.

7. A according to claim 6 wherein format specification of the data words corresponds to an RS 232 interface.

8. A device for the transmission of information via an optical data transmission line having a transmission end and a receiving end, said device comprising: an optoelectronic interface comprising a transmitter side at the transmission end and a receiver side at the receiver end the interface having a light transmitter at the transmitter side, and electronics which modulate transmitted light corresponding to a data signal to be transmitted to obtain a modulated input signal and having a light-sensitive receive element at the receiver side, an output signal of which is modulated analogously to the modulated input signal to obtain a modulated receive signal, a monitoring device being additionally provided at the receiver side which, independently of the modulation of the receive signal, monitors and records the presence or absence of transmitted input signal as a signal monitoring output and displays it at a signal monitoring device, wherein, transmitter side, devices are provided for, clock-pulse-controlled lowering and raising of intensity of transmitted light energy, the intensity of the transmitted light energy in the lowered state being below a threshold value at which the monitoring device records the presence of a data transmission signal and the intensity of the light energy in a raised state being above a threshold value at which the monitoring device records the presence of a data transmission signal to obtain an encoded output signal encoded in correspondence with the lowering and raising of intensity of transmitted light energy, and an evaluation device being provided for the evaluation of the output signal encoded corresponding to the raising and lowering of the transmission signal.

9. A device according to claim 8 wherein a laser is provided as a light transmission device.

10. A device according to claim 9 wherein a separate microprocessor is provided for the evaluation of the encoded signal monitoring signal.

11. A device according to claim 10 wherein the evaluation logic is implemented by software.

12. A device according to claim 9 wherein clock-pulse-controllable drive electronics for a laser are provided as a device for raising and lowering the light energy.

13. A device according to claim 12 wherein a device is provided for the clock-pulse-controlled switching on and off of laser supply voltage.

14. A device according to claim 10 wherein clock-pulse-controllable drive electronics for a laser are provided as a device for raising and lowering the light energy.

15. A device according to claim 14 wherein a device is provided for the clock-pulse-controlled switching on and off of laser supply voltage.

16. A device according to claim 11 wherein clock-pulse-controllable drive electronics for a laser are provided as a device for raising and lowering the light energy.

17. A device according to claim 16 wherein a device is provided for the clock-pulse-controlled switching on and off of laser supply voltage.

18. The method of claim 1 wherein the receive element comprises a photodiode.

19. The method of claim 1 wherein the light transmitter comprises a laser.

20. The method of claim 19 wherein the laser is driven by a laser supply voltage that is switched off and on in encoded form.
